(19) United States
(12) Patent Application Publication
(10) Pub. No.: US 2025/0179334 A1
(43) Pub. Date: Jun. 5, 2025

(54) DECORATIVE FILM FOR EXTERIORS

(71) Applicant: 3M INNOVATIVE PROPERTIES COMPANY, St. Paul, MN (US)

(72) Inventor: Hidetoshi Abe, Tendo city (JP)

(21) Appl. No.: 18/834,485

(22) PCT Filed: Mar. 15, 2023
(86) PCT No.: PCT/IB2023/052542

§ 371 Date: Jul. 30, 2024

(30) Foreign Application Priority Data
Apr. 5, 2022 (JP) 2022-062987

(51) Int. Cl. C09J 7/24; B32B 27/08; B32B 27/30; C09J 7/30; C09J 133/04

(52) U.S. Cl. CPC C09J 7/245; B32B 27/08; B32B 27/304; B32B 27/308; C09J 7/30; C09J 133/04; B32B 2250/02; B32B 2250/24; B32B 2307/3065; B32B 2307/412; B32B 2307/7376; B32B 2405/00; B32B 2451/00; C09J 2203/306; C09J 2400/123; C09J 2433/006

(57) ABSTRACT

The decorative film for exteriors of an embodiment includes a fluororesin-based film layer and a colored adhesive layer, wherein the colored adhesive layer contains a carboxy group-containing (meth)acrylic polymer, an amino group-containing (meth)acrylic polymer, and from 5 mass % to 50 mass % of titanium oxide based on mass of the colored adhesive layer; the fluororesin-based film layer includes a first layer containing a vinylidene fluoride-based resin and a second layer containing a methacrylate-based resin; the second layer of the fluororesin-based film layer is in contact with the colored adhesive layer; and the decorative film for exteriors has a thickness of 250 μm or less, and a total heat release for 20 minutes after start of heating is 8 MJ/m² or lower as measured in accordance with the ISO 5660-1 cone calorimeter heat release test.

The present disclosure relates to a decorative film for exteriors.

Decorative films including a polyvinyl chloride (PVC) film are widely used in exterior applications. PVC films have excellent weather resistance and coloration and thus are useful for exterior applications.

In general, PVC films are not sufficiently solvent-resistant, and paint deposited on the surface of a PVC film is adhered on the surface and difficult to remove. In addition, a plasticizer commonly added to soften a PVC resin tends to migrate to the surface over time. A plasticizer has a property of adsorbing dirt and thus may reduce the weather resistance and durability of a PVC film. Thus, decorative films used for the exteriors of vehicles, such as those of railways, desirably having anti-graffiti are preferably non-PVC based. Anti-graffiti means properties of preventing deposition of paint or the like on the decorative film surface or being able to easily remove paint or the like even though it is temporarily deposited on the decorative film surface. Fluororesin films are non-PVC based and have excellent weather resistance, anti-smudge properties, and anti-graffiti, and thus decorative films including a fluororesin film have been proposed.

Patent Document 1 (JP 10-315388 A) describes “a film for decoration, the film having a decorative metal layer on a surface on an adherend side of a transparent support, wherein the support comprises a copolymer of tetrafluoroethylene, hexafluoropropylene, and vinylidene fluoride”.

Patent Document 2 (JP 2008-201920 A) describes “a laminated adhesive sheet for a metal decorative plate, the laminated adhesive sheet having a fluorine-based resin-containing layer on one surface of a substrate film made of a thermoplastic resin and an adhesive layer on another surface of the substrate film, wherein an amount of peeling is 10 mm or less after 24 hours” in a prescribed constant load test.

Patent Document 3 (JP 09-062188 A) describes “an adhesive sheet, wherein an acrylic resin formed by copolymerization of an acrylic monomer having an ultraviolet light-absorbing group in a molecule and another acrylic monomer having no ultraviolet light-absorbing group in a molecule, and a colored layer composed of a colorant are laminated on an activation-treated surface of a fluororesin film of which one surface is activation-treated, and an adhesive layer and a release sheet are sequentially laminated on the colored layer surface”.

Patent Document 4 (JP 10-120801 A) describes “a fluorine-containing resin film produced by a casting method, the fluorine-containing resin film having a modulus of elasticity of 50 kg/mm² or higher and an elongation of 50% or higher” and “an adhesive sheet comprising an adhesive layer provided on at least one surface of the fluorine-containing resin film”.

### SUMMARY OF INVENTION

### Technical Problem

Decorative films including a fluororesin film have several problems. First, obtaining a fluororesin film colored in a desired color is disadvantageous from the viewpoint of production cost, especially in production in small lots. Second, laminating the colored layer on the fluororesin film requires an additional process and does not easily control the opacity of the decorative film due to the refractive index or the like of the fluororesin film. Third, increasing the adhesion between the fluororesin film and the adhesive layer is difficult.

The present disclosure provides a fluororesin-based decorative film capable of solving the problems described above, used for the exteriors of vehicles or the like, and having weather resistance, anti-smudge properties, anti-graffiti, and flame retardance.

### Solution to Problem

The present inventor has found that laminating a colored adhesive layer containing a (meth)acrylic polymer and titanium oxide on a fluororesin-based film having a specific laminated structure makes it possible to produce a decorative film having weather resistance, anti-smudge properties, anti-graffiti, and flame retardance, and exhibiting a variety of colors by a simple process at low cost.

An embodiment provides a decorative film for exteriors, including a fluororesin-based film layer and a colored adhesive layer, wherein
the colored adhesive layer contains a carboxy group-containing (meth)acrylic polymer, an amino group-containing (meth)acrylic polymer, and from 5 mass % to 50 mass % of titanium oxide based on mass of the colored adhesive layer;
the fluororesin-based film layer includes a first layer containing a vinylidene fluoride-based resin and a second layer containing a methacrylate-based resin;
the second layer of the fluororesin-based film layer is in contact with the colored adhesive layer; and
the decorative film for exteriors has a thickness of 250 μm or less, and a total heat release for 20 minutes after start of heating is 8 MJ/m² or lower as measured in accordance with the ISO 5660-1 cone calorimeter heat release test.

### Advantageous Effects of Invention

The present disclosure can provide the fluororesin-based decorative film used for the exteriors of vehicles or the like and having weather resistance, anti-smudge properties, anti-graffiti, and flame retardance by a simple process at low cost. In addition, the present disclosure can provide the decorative film for exteriors, which exhibits a variety of colors, by appropriately changing a colorant blended in the colored adhesive layer.

Note that the above description is not construed as disclosure of all of embodiments of the present invention and advantages related to the present invention.

### BRIEF DESCRIPTION OF DRAWINGS

FIG. 1 is a schematic cross-sectional view of a decorative film for exteriors of an embodiment.

### DESCRIPTION OF EMBODIMENTS

Hereinafter, the present invention will be described in more detail with reference to the drawings for the purpose of illustrating representative embodiments of the present invention, but the present invention is not limited to these embodiments.

In the present disclosure, the term “(meth)acrylic” refers to acrylic or methacrylic, and the term “(meth)acrylate” refers to acrylate or methacrylate.

In the present disclosure, the term “film” encompasses articles referred to as “sheets”.

In the present disclosure, “pressure-sensitive adhesive(ness)” refers to the characteristic of a material or composition that the material or composition adheres to various surfaces by application of little pressure for a short time in the temperature range of usage, such as from 0° C. to 50° C., and does not exhibit a phase change (from liquid to solid). In the present disclosure, “adhesive(ness)” is used interchangeably with “pressure-sensitive adhesive(ness)”.

In the present disclosure, “disposed on” refers to not only the case of being directly disposed on, but also the case of being indirectly disposed on, that is, disposed via another material or layer on.

In the present disclosure, “titanium oxide” is used interchangeably with “titanium dioxide (TiO₂)”.

A decorative film for exteriors of an embodiment includes a fluororesin-based film layer and a colored adhesive layer. The colored adhesive layer contains a carboxy group-containing (meth)acrylic polymer, an amino group-containing (meth)acrylic polymer, and from approximately 5 mass % to approximately 50 mass % of titanium oxide based on the mass of the colored adhesive layer. The fluororesin-based film layer includes a first layer containing a vinylidene fluoride-based resin and a second layer containing a methacrylate-based resin, and the second layer of the fluororesin-based film layer is in contact with the colored adhesive layer. The thickness of the decorative film for exteriors is 250 μm or less, and the total heat release for 20 minutes after start of heating is 8 MJ/m² or lower as measured in accordance with the ISO 5660-1 cone calorimeter heat release test. Hereinafter, the decorative film for exteriors is also referred to simply as a “decorative film” in the present disclosure.

In an embodiment, the decorative film is composed of the fluororesin-based film layer and the colored adhesive layer. “Composed of the fluororesin-based film layer and the colored adhesive layer” means that the decorative film contains no other layer than the fluororesin-based film layer and the colored adhesive layer as well as a liner to be removed at the time of use. The decorative film of this embodiment has a simple layer structure and thus can more advantageously accommodate regulations relating to flame retardance in each country.

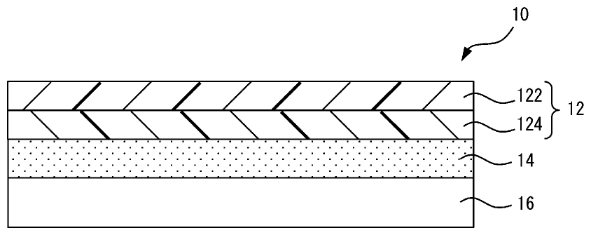

FIG. 1 illustrates a schematic cross-sectional view of a decorative film for exteriors of an embodiment. The decorative film 10 for exteriors includes a fluororesin-based film layer 12 and a colored adhesive layer 14. The fluororesin-based film layer 12 includes a first layer 122 containing vinylidene fluoride-based resin and a second layer 124 containing a methacrylate-based resin, and the second layer 124 is in contact with the colored adhesive layer 14. The decorative film 10 of FIG. 1 further includes a liner 16 as an optional component. The liner 16 is removed before adhesion of the decorative film 10 to an adherend.

The vinylidene fluoride-based resin may be a homopolymer of vinylidene fluoride or a copolymer of vinylidene fluoride and a copolymerizable monomer. Examples of the copolymerizable monomer include tetrafluoroethylene, hexafluoropropylene, trifluorochloroethylene, and vinyl fluoride. A structural unit derived from vinylidene fluoride can be contained in the vinylidene fluoride-based resin in an amount of approximately 30 mass % or higher, approximately 40 mass % or higher, or approximately 50 mass % or higher, and 100 mass % or lower, approximately 95 mass % or lower, or approximately 90 mass % or lower.

The methacrylate-based resin may be a homopolymer of methyl methacrylate or a copolymer of methyl methacrylate and a copolymerizable monomer. Examples of the copolymerizable monomer include alkyl methacrylates in which the alkyl group has from 2 to 4 carbon atoms, alkyl acrylates in which the alkyl group has from 1 to 8 carbon atoms, styrene, α-methylstyrene, acrylonitrile, (meth)acrylic acid, and (meth)acrylamide. The methacrylate-based resin may be a blend of a homopolymer of methyl methacrylate and an acrylic rubber. A structural unit derived from methyl methacrylate can be contained in the methacrylate-based resin in an amount of approximately 30 mass % or higher, approximately 40 mass % or higher, or approximately 50 mass % or higher, and 100 mass % or lower, approximately 95 mass % or lower, or approximately 90 mass % or lower.

The first layer contains the vinylidene fluoride-based resin as a main component. The first layer may be composed of the vinylidene fluoride-based resin or a blend of the vinylidene fluoride-based resin and another resin.

The second layer contains the methacrylate-based resin as a main component. The second layer may be composed of the methacrylate-based resin or a blend of the methacrylate-based resin and another resin.

In an embodiment, both the first layer and the second layer contain the same type of resin. Specifically, the first layer further contains the methacrylate-based resin; the second layer further contains the vinylidene fluoride-based resin; or the first layer further contains the methacrylate-based resin, and the second layer further contains the vinylidene fluoride-based resin. This embodiment can increase the adhesion between the first layer and the second layer and reduce the refractive index difference between the first layer and the second layer, and can increase the transparency of the fluororesin-based film layer.

In an embodiment, the first layer contains from approximately 95 parts by mass to approximately 50 parts by mass of the vinylidene fluoride-based resin and from approximately 5 parts by mass to approximately 50 parts by mass of the methacrylate-based resin. The first layer with a content of the vinylidene fluoride-based resin of approximately 50 parts by mass or greater can effectively impart weather resistance, anti-smudge properties, and anti-graffiti to the decorative film. The first layer with a content of the methacrylate-based resin of approximately 5 parts by mass or greater can further increase the adhesion with the second layer and can increase the transparency of the fluororesin-based film layer.

In an embodiment, the second layer contains from approximately 95 parts by mass to approximately 5 parts by mass and preferably from approximately 95 parts by mass to approximately 50 parts by mass of the methacrylate-based resin, and from approximately 5 parts by mass to approximately 95 parts by mass and preferably from approximately 5 parts by mass to approximately 50 parts by mass of the vinylidene fluoride-based resin. The second layer with a content of the methacrylate-based resin approximately 5 parts by mass or greater can increase the adhesion with the colored adhesive layer and can more uniformly disperse an optionally used additive, such as a UV absorbent or a hindered amine light stabilizer. The second layer with a content of the vinylidene fluoride-based resin approximately 5 parts by mass or greater can further increase the adhesion with the first layer and can increase the transparency of the fluororesin-based film layer.

The second layer may contain at least one selected from the group consisting of a UV absorbent and a hindered amine light stabilizer. An adhesive contained in an adhesive layer is generally known to be deteriorated by ultraviolet light. The second layer containing at least one selected from the group consisting of a UV absorbent and a hindered amine light stabilizer is provided as a UV deterioration preventing layer in contact with the colored adhesive layer, and this can effectively prevent deterioration of the adhesive polymer contained in the colored adhesive layer due to ultraviolet light passing through the fluororesin-based film layer. In addition, fading of the colored adhesive layer can more effectively prevented by a synergistic effect of ultraviolet light absorption by titanium oxide contained in the colored adhesive layer and ultraviolet light absorption or stabilization by at least one selected from the group consisting of a UV absorbent and a hindered amine light stabilizer contained in the second layer, for example, by the extended wavelength range associated with ultraviolet light absorption or stabilization.

The UV absorbent preferably has a high molecular weight to prevent its volatilization. Examples of the UV absorbent include benzotriazole compounds, anilide oxalate compounds, and benzophenone compounds. Examples of the benzotriazole compound include 2-[2-hydroxy-3,5-bis(α,α-dimethylbenzyl)phenyl]-2H-benzotriazole, 2-(3,5-di-t-butyl-2-hydroxyphenyl)benzotriazole, 2-(3,5-di-t-butyl-2-hydroxyphenyl)-5-chlorobenzotriazole, 2-(3,5-di-t-amyl-2-hydroxyphenyl)benzotriazole, and 2-(3-t-butyl-5-methyl-2-hydroxyphenyl)-5-chlorobenzotriazole. Examples of the anilide oxalate compound include bis(anilide) 2-ethoxy-2′-ethyl oxalate and bis(anilide) 2-ethoxy-5-t-butyl-2′-ethyl oxalate. Examples of the benzophenone compound include 2-hydroxy-4-n-octoxybenzophenone.

Examples of the hindered amine light stabilizer include Tinuvin (trade name) 292, Tinuvin (trade name) 123, Tinuvin (trade name) 622SF, and Tinuvin (trade name) 770 (all available from BASF Japan Ltd., Chuo-ku, Tokyo, Japan).

The total content of the UV absorbent and the hindered amine light stabilizer can be from approximately 0.1 mass % to approximately 15 mass % and preferably from approximately 0.5 mass % to approximately 5 mass % based on the mass of the second layer.

The first layer or the second layer may contain an additive, such as an antioxidant, a pigment, a dispersant, or a coupling agent, as an optional component.

The fluororesin-based film layer can be formed by co-extruding or inflation molding a first resin composition containing components of the first layer and a second resin composition containing components of the second layer. For the second layer containing a UV absorbent or a hindered amine light stabilizer, the UV absorbent or the hindered amine light stabilizer and the methacrylate-based resin are mixed to prepare a premix, then another component, such as vinylidene fluoride-based resin, is mixed in the premix, thereby the UV absorbent or the hindered amine light stabilizer can be more uniformly dissolved or dispersed in the second layer.

The fluororesin-based film layer may vary in thickness; the thickness can be, for example, approximately 10 μm or greater, approximately 12 μm or greater, or approximately 15 μm or greater, and approximately 200 μm or less, approximately 150 μm or less, or approximately 100 μm or less. From the viewpoints of elongation and nonflammability of the decorative film, the thickness of the fluororesin-based film layer is preferably approximately 80 μm or less and more preferably approximately 50 μm or less.

The first layer may vary in thickness; the thickness can be approximately 1% or greater, approximately 5% or greater, or approximately 10% or greater, and approximately 95% or less, approximately 90% or less, or approximately 80% or less of the thickness of the fluororesin-based film layer.

The second layer may vary in thickness; the thickness can be approximately 5% or greater, approximately 10% or greater, or approximately 20% or greater, and approximately 99% or less, approximately 95% or less, or approximately 90% or less of the thickness of the fluororesin-based film layer.

For the second layer containing a UV absorbent or a hindered amine light stabilizer, the thickness of the second layer is preferably approximately 20% or greater of the thickness of the fluororesin-based film layer. The second layer with a thickness in the above range can effectively protect the colored adhesive layer in contact with the second layer from ultraviolet light.

The fluororesin-based film layer is preferably colorless and transparent or preferably has such a degree of transparency that the presence of the color of the colored adhesive layer can be visually recognized through the fluororesin-based film layer. In an embodiment, the total light transmittance of the fluororesin-based film layer in a wavelength range from 380 to 780 nm is approximately 80% or higher, approximately 85% or higher, or approximately 90% or higher, and 100% or lower. The total light transmittance in the present disclosure is measured in accordance with JIS A 5759:2008. When the decorative film is applied to an adherend, the fluororesin-based film having the above total light transmittance enables the presence of the color of the colored adhesive layer to be visually recognized without substantially changing the original hue, lightness, and saturation of the colored adhesive layer. Thus, the workload resulting from color matching when the colored adhesive layer is formed can be reduced.

The surface of the second layer of the fluororesin-based film layer may be surface-treated by corona treatment, plasma treatment, or the like. Performing the surface treatment can further increase the adhesion between the second layer of the fluororesin film layer and the colored adhesive layer.

The colored adhesive layer contains a carboxy group-containing (meth)acrylic polymer, an amino group-containing (meth)acrylic polymer, and from approximately 5 mass % to approximately 50 mass % of titanium oxide based on the mass of the colored adhesive layer. The colored adhesive layer contains a carboxy group-containing (meth)acrylic polymer and an amino group-containing (meth)acrylic polymer, which enables titanium oxide to be contained in the colored adhesive layer in a high concentration and in a uniformly dispersed state by utilizing the interaction between titanium oxide and the carboxy group or the amino group. Thus, a decorative film exhibiting uniform appearance can be provided even when the colored adhesive layer is relatively thinned. In addition, the colored adhesive layer can be thinned, and this is also advantageous from the viewpoint of nonflammability.

The carboxy group-containing (meth)acrylic polymer increases cohesive force of the colored adhesive layer due to the presence of the carboxy group and can improve adhesive strength. The presence of the carboxy group and/or the improved cohesive force also contributes to increasing the adhesion between the colored adhesive layer and the second layer of the fluororesin-based film layer.

The carboxy group-containing (meth)acrylic polymer can be obtained by copolymerizing a polymerizable composition containing a (meth)acrylic monomer and a carboxy group-containing monomer and, as necessary, a monomer having another monoethylenic unsaturated group. In the present disclosure, a (meth)acrylic monomer, a carboxy group-containing monomer, an amino group-containing monomer, and a monomer having another monoethylenic unsaturated group are collectively referred to as polymerizable components. The (meth)acrylic monomer, the carboxy group-containing monomer, and the monomer having another monoethylenic unsaturated group may be used alone or may be used in combination of two or more types.

The (meth)acrylic monomer typically includes an alkyl (meth)acrylate. The number of carbon atoms of the alkyl group of the alkyl (meth)acrylate may be from 1 to 12. Examples of the alkyl (meth)acrylate include linear or branched alkyl (meth)acrylate, such as methyl (meth)acrylate, ethyl (meth)acrylate, n-butyl (meth)acrylate, isobutyl (meth)acrylate, 2-methylbutyl (meth)acrylate, isoamyl (meth)acrylate, n-hexyl (meth)acrylate, n-octyl (meth)acrylate, isooctyl (meth)acrylate, 2-ethylhexyl (meth)acrylate, n-nonyl (meth)acrylate, isononyl (meth)acrylate, n-decyl (meth)acrylate, isodecyl (meth)acrylate, and n-dodecyl (meth)acrylate; and alicyclic (meth)acrylate, such as cyclohexyl (meth)acrylate, 4-t-butylcyclohexyl (meth)acrylate, and isobornyl (meth)acrylate. The alkyl (meth)acrylate preferably includes methyl (meth)acrylate, n-butyl (meth)acrylate, 2-ethylhexyl acrylate, or a combination of these.

The alkyl (meth)acrylate constitutes the main component of the carboxy group-containing (meth)acrylic polymer. In an embodiment, the carboxy group-containing (meth)acrylic polymer is obtained by copolymerizing a polymerizable composition containing the alkyl (meth)acrylate in an amount of approximately 50 mass % or greater, approximately 70 mass % or greater, or approximately 80 mass % or greater, and approximately 99.5 mass % or less, approximately 99 mass % or less, or approximately 98 mass % or less, relative to the mass of the polymerizable components, and includes structural units derived from the alkyl (meth)acrylate in the mass ratio described above.

The (meth)acrylic monomer may include aromatic (meth)acrylate such as phenyl (meth)acrylate and p-tolyl (meth)acrylate; phenoxy alkyl (meth)acrylate such as phenoxy ethyl (meth)acrylate; alkoxy alkyl (meth)acrylate such as methoxypropyl (meth)acrylate and 2-methoxybutyl (meth)acrylate; or cyclic ether-containing (meth)acrylate such as glycidyl (meth)acrylate or tetrahydrofurfuryl (meth)acrylate.

Examples of the carboxy group-containing monomer include (meth)acrylic acid, phthalic acid monohydroxyethyl (meth)acrylate, β-carboxyethyl (meth)acrylate, 2-(meth)acryloyloxyethyl succinic acid, 2-(meth)acryloyloxyethyl hexahydrophthalic acid, crotonic acid, itaconic acid, fumaric acid, citraconic acid, and maleic acid. As the carboxy group-containing monomer, (meth)acrylic acid is preferred. In the present disclosure, a substance that corresponds to the (meth)acrylic monomer and the carboxy group-containing monomer, such as (meth)acrylic acid, is treated as a carboxy group-containing monomer.

In an embodiment, the carboxy group-containing (meth)acrylic polymer is obtained by copolymerizing a polymerizable composition containing the carboxy group-containing monomer in an amount of approximately 0.5 mass % or greater, approximately 1 mass % or greater, or approximately 2 mass % or greater, and approximately 15 mass % or less, approximately 10 mass % or less, or approximately 8 mass % or less, relative to the mass of the polymerizable components, and includes structural units derived from the carboxy group-containing monomer in the mass ratio described above.

Examples of the (meth)acrylic monomer or the monomer having another monoethylenic unsaturated group include amide group-containing monomers, such as (meth)acrylamide, N-vinylpyrrolidone, and N-vinylcaprolactam; hydroxy group-containing monomers, such as 2-hydroxyethyl (meth)acrylate, 2-hydroxypropyl (meth)acrylate, and 4-hydroxybutyl (meth)acrylate; unsaturated nitriles, such as (meth)acrylonitrile; aromatic vinyl monomers, such as styrene, α-methylstyrene, and vinyl toluene; and vinyl esters, such as vinyl acetate.

The copolymerization of the carboxy group-containing (meth)acrylic polymer can be performed by radical polymerization. As the radical polymerization, a known polymerization method can be utilized, such as solution polymerization, suspension polymerization, emulsion polymerization, and bulk polymerization. It is advantageous to use solution polymerization that can easily synthesize a polymer with a high molecular weight. As the polymerization initiator, for example, an organic peroxide such as benzoyl peroxide, lauroyl peroxide, or bis(4-tert-butylcyclohexyl)peroxydicarbonate; or an azo-based polymerization initiator such as 2,2′-azobisisobutyronitrile, 2,2′-azobis(2-methylbutyronitrile), dimethyl-2,2-azobis(2-methylpropionate), 4,4′-azobis(4-cyanovalerianic acid), dimethyl 2,2′-azobis(2-methylpropionate), or azobis(2,4-dimethylvaleronitrile) (AVN) can be used. The polymerization initiator is used typically in an amount of approximately 0.01 parts by mass or greater, or approximately 0.05 parts by mass or greater, and approximately 5 parts by mass or less, or approximately 3 parts by mass or less, relative to 100 parts by mass of the polymerizable components.

The amino group-containing (meth)acrylic polymer increases cohesive force of the colored adhesive layer by the interaction with the carboxy group-containing (meth)acrylic polymer and can improve adhesive properties of the colored adhesive layer. The improved cohesive force also contributes to increasing the adhesion between the colored adhesive layer and the second layer of the fluororesin-based film layer.

The amino group-containing (meth)acrylic polymer can be obtained by copolymerizing a polymerizable composition containing a (meth)acrylic monomer and an amino group-containing monomer and, as necessary, a monomer having another monoethylenic unsaturated group. The (meth)acrylic monomer, the amino group-containing monomer, and the monomer having another monoethylenic unsaturated group may be used alone or may be used in combination of two or more types.

As the (meth)acrylic monomer and the monomer having another monoethylenic unsaturated group, the groups identical to those described for the carboxy group-containing (meth)acrylic polymer can be used.

The alkyl (meth)acrylate constitutes the main component of the amino group-containing (meth)acrylic polymer. In an embodiment, the amino group-containing (meth)acrylic polymer is obtained by copolymerizing a polymerizable composition containing the alkyl (meth)acrylate in an amount of approximately 50 mass % or greater, approximately 70 mass % or greater, or approximately 80 mass % or greater, and approximately 99.5 mass % or less, approximately 99 mass % or less, or approximately 98 mass % or less, relative to the mass of the polymerizable components, and includes structural units derived from the alkyl (meth)acrylate in the mass ratio described above.

Examples of the amino group-containing monomer include aminoalkyl (meth)acrylate such as aminoethyl (meth)acrylate; monoalkylaminoalkyl (meth)acrylate such as butylaminoethyl (meth)acrylate; dialkylaminoalkyl (meth)acrylates such as N,N-dimethylaminoethyl acrylate (DMAEA) and N,N-dimethylaminoethyl methacrylate (DMAEMA); dialkylaminoalkyl (meth)acrylamides such as N,N-dimethylaminopropyl acrylamide (DMAPAA) and N,N-dimethylaminopropyl methacrylamide; and dialkylaminoalkyl vinyl ethers such as N,N-dimethylaminoethyl vinyl ether and N,N-diethylaminoethyl vinyl ether. As the amino group-containing monomer, dialkylamino alkyl(meth)acrylate such as N,N-dimethylaminoethyl acrylate (DMAEA) or N,N-dimethylaminoethyl methacrylate (DMAEMA) is preferred. In the present disclosure, a substance that corresponds to the (meth)acrylic monomer and the amino group-containing monomer, such as aminoethyl (meth)acrylate, is treated as an amino group-containing monomer.

In an embodiment, the amino group-containing (meth)acrylic polymer is obtained by copolymerizing a polymerizable composition containing the amino group-containing monomer in an amount of approximately 0.5 mass % or greater, approximately 1 mass % or greater, or approximately 2 mass % or greater, and approximately 20 mass % or less, approximately 15 mass % or less, or approximately 10 mass % or less, relative to the mass of the polymerizable components, and includes structural units derived from the amino group-containing monomer in the mass ratio described above.

The amino group-containing (meth)acrylic polymer is preferably an amino group-containing (meth)acrylic polymer containing no monomer unit derived from aromatic vinyl monomers (hereinafter, in the present disclosure, also referred to as “amino group-containing non-aromatic (meth)acrylic polymer”). The amino group-containing non-aromatic (meth)acrylic polymer has excellent miscibility with the carboxy group-containing (meth)acrylic polymer and thus enables the interaction with the carboxy group-containing (meth)acrylic polymer to be more effective.

The amino group-containing non-aromatic (meth)acrylic polymer contains no structural units derived from aromatic vinyl monomers. Examples of the aromatic vinyl monomer include styrene, α-methylstyrene, vinyltoluene, vinylnaphthalene, vinylanthracene, vinylanthraquinone, (meth)acrylamide of aromatic amine, and (meth)acrylate of hydroxy group-containing aromatic compounds. Examples of the aromatic amine include aniline, benzylamine, naphthylamine, aminoanthracene, aminoanthraquinone, and derivatives of these. Examples of the hydroxy group-containing aromatic compound include hydroxy group-containing compounds corresponding to the aromatic amines described above.

The copolymerization of the amino group-containing (meth)acrylic polymer can be performed by radical polymerization in the same manner as for the copolymerization of the carboxy group-containing (meth)acrylic polymer. The polymerization method, the polymerization initiator and the used amount thereof are the same as those described for the copolymerization of the carboxy group-containing (meth)acrylic polymer.

In the colored adhesive layer, at least one of the carboxy group-containing (meth)acrylic polymer or the amino group-containing (meth)acrylic polymer functions as an acrylic adhesive polymer. The acrylic adhesive polymer imparts pressure-sensitive adhesiveness to the colored adhesive layer at the operating temperature (e.g., 5° C. to 35° C.).

The glass transition temperature (Tg) of the acrylic adhesive polymer may be approximately −70° C. to approximately −20° C. In an embodiment, the glass transition temperature of the acrylic adhesive polymer is approximately −65° C. or higher, or approximately −60° C. or higher, and approximately −25° C. or lower, or approximately −30° C. or lower. The acrylic adhesive polymer with a glass transition temperature of approximately −70° C. or higher can impart adhesive strength and retention to the colored adhesive layer. The acrylic adhesive polymer with a glass transition temperature of approximately −20° C. or lower can effectively impart initial adhesion (tackiness) to the colored adhesive layer.

The glass transition temperature (Tg) of the acrylic adhesive polymer can be determined as the calculated glass transition temperature using the following Fox equation (Fox, T. G., Bull. Am. Phys. Soc., 1 (1956), p. 123) assuming that each polymer is copolymerized from n types of monomers:

$$\frac{1}{T g + 273.15} = {\sum }_{i = 1}^{n} ( \frac{{X}_{i}}{T {g}_{i} + 273.15} ) \qquad [ Equation 1 ]$$

where Tgᵢ represents the glass transition temperature (° C.) of a homopolymer of a component i, Xᵢ represents the mass fraction of the monomer of the component i added during polymerization, and i is a natural number from 1 to n, and:

$${{\sum }^{n}}_{i = 1} {X}_{i} = 1. \qquad [ Equation 2 ]$$

In an embodiment, the weight average molecular weight (Mw) of the acrylic adhesive polymer is approximately 150000 or greater, approximately 200000 or greater, or approximately 250000 or greater, and approximately 2000000 or less, approximately 1500000 or less, or approximately 1000000 or less. In the present disclosure, “weight average molecular weight” is a molecular weight in terms of polystyrene standard by the gel permeation chromatography (GPC) method.

The mass ratio of the carboxy group-containing (meth)acrylic polymer to the amino group-containing (meth)acrylic polymer is 100:approximately from 0.1 to 50, 100:approximately from 1 to 40, or 100:approximately from 2 to 30 (in a case where the carboxy group-containing (meth)acrylic polymer functions as the acrylic adhesive polymer), or approximately from 0.1 to 50:100, approximately from 1 to 40:100, or approximately from 2 to 30:100 (in a case where the amino group-containing (meth)acrylic polymer functions as the acrylic adhesive polymer).

In an embodiment, another (meth)acrylic polymer that is different from the (meth)acrylic polymer functioning as an acrylic adhesive polymer may function as an acrylic polymer additive. That is, in a case where the carboxy group-containing (meth)acrylic polymer functions as the acrylic adhesive polymer, the amino group-containing (meth)acrylic polymer may function as the acrylic polymer additive, and in a case where the amino group-containing (meth)acrylic polymer functions as the acrylic adhesive polymer, the carboxy group-containing (meth)acrylic polymer may function as the acrylic polymer additive. By acid (carboxy group)-base (amino group) interaction with the acrylic adhesive polymer, the acrylic polymer additive can suppress reduction of the cohesive force due to depolymerization of the acrylic adhesive polymer caused by exposure to sunlight or the like, and can maintain the adhesive strength to a desired level.

In an embodiment, the carboxy group-containing (meth)acrylic polymer is the acrylic adhesive polymer, and the amino group-containing (meth)acrylic polymer is the acrylic polymer additive.

The glass transition temperature (Tg) of the acrylic polymer additive can be approximately 20° C. to approximately 120° C. In an embodiment, the glass transition temperature of the acrylic polymer additive is approximately 30° C. or higher, or approximately 45° C. or higher, and approximately 100° C. or lower, or approximately 80° C. or lower. By setting the glass transition temperature of the acrylic polymer additive to approximately 20° C. or higher, it is possible to suppress reduction of the cohesive force due to depolymerization of the acrylic adhesive polymer caused by exposure to sunlight or the like, and to maintain the adhesive strength to a desired level. By setting the glass transition temperature of the acrylic polymer additive to approximately 100° C. or lower, adhesiveness in an ordinary temperature range can be secured. The glass transition temperature of the acrylic polymer additive can be determined by using the Fox equation similarly to the acrylic adhesive polymer.

In an embodiment, the weight average molecular weight (Mw) of the acrylic polymer additive is approximately 1000 or greater, approximately 5000 or greater, or approximately 10000 or greater, and approximately 200000 or less, approximately 100000 or less, or approximately 80000 or less.

In an embodiment, the glass transition temperature of the carboxy group-containing (meth)acrylic polymer or amino group-containing (meth)acrylic polymer that functions as the acrylic adhesive polymer is approximately −70° C. to approximately −20° C., the glass transition temperature of the carboxy group-containing (meth)acrylic polymer or amino group-containing (meth)acrylic polymer that functions as the acrylic polymer additive is from 20° C. to 120° C., and the content of the acrylic polymer additive in the colored adhesive layer is approximately 11 parts by mass to approximately 40 parts by mass per 100 parts by mass of the acrylic adhesive polymer. The content of the acrylic polymer additive is preferably approximately 12 parts by mass or greater, or approximately 15 parts by mass or greater, and approximately 30 parts by mass or less, or approximately 25 parts by mass or less, per 100 parts by mass of the acrylic adhesive polymer. By setting the content of the acrylic polymer additive to approximately 11 parts by mass or greater per 100 parts by mass of the acrylic adhesive polymer, the acrylic polymer additive having a high glass transition temperature, which is at 20° C. to 120° C., can suppress reduction of the cohesive force of the acrylic adhesive polymer caused by exposure to sunlight and can maintain the adhesive strength of the colored adhesive layer to a desired level. By setting the content of the acrylic polymer additive to approximately 40 parts by mass or less per 100 parts by mass of the acrylic adhesive polymer, adhesiveness can be secured even at a low temperature.

The colored adhesive layer contains from approximately 5 mass % to approximately 50 mass % of titanium oxide based on the mass of the colored adhesive layer. The content of titanium oxide in the colored adhesive layer can be approximately 10 mass % or higher or approximately 15 mass % or higher and approximately 45 mass % or lower or approximately 40 mass % or lower. The colored adhesive layer contains from approximately 5 mass % to approximately 50 mass % of titanium oxide, and this can partially or completely hide an adherend surface to which the decorative film is applied. For example, for an adherend surface having graffiti drawn using paint or the like, the decorative film is applied from above the surface, and this can cover and hide the graffiti. Titanium oxide acts as a flame retardant and can also increase flame retardance of the decorative film. Furthermore, when a second colorant is used, titanium oxide can prevent a change in lightness due to a slight difference in the blended amount of the second colorant and can facilitate color matching of the colored adhesive layer.

The average particle size of titanium oxide can be approximately 0.1 μm or greater or approximately 0.15 μm or greater and approximately 5 μm or less or approximately 3 μm or less. The average particle size in the present disclosure is a value not for aggregated particles (secondary particles) but for primary particles. The average particle size of titanium oxide is a volume cumulative particle size D₅₀ that can be determined by laser diffraction/scattering particle size distribution measurement.

The colored adhesive layer may further contain a second colorant other than titanium oxide. Examples of the second colorant include pigments and dyes. A pigment or dye can each be used alone, or two or more of them can each be used in combination. The form of the pigment and dye is not particularly limited and may have undergone dispersion treatment.

Examples of the pigment include inorganic pigments, such as zinc carbonate, zinc oxide, zinc sulfide, talc, kaolin, calcium carbonate, carbon black, chrome yellow, yellow iron oxide, colcothar, red iron oxide, barium sulfate, alumina, zirconia, iron oxide-based pigments, iron hydroxide-based pigments, chromium oxide-based pigments, spinel-type calcined pigments, chromic acid-based pigments, chrome vermilion-based pigments, iron blue-based pigments, aluminum powder-based pigments, bronze powder-based pigments, and calcium phosphate; and organic pigments, such as phthalocyanine-based pigments (such as phthalocyanine blue and phthalocyanine green), azo-based pigments, condensed azo-based pigments, azo lake-based pigments, anthraquinone-based pigments, indigo-based pigments, thioindigo-based pigments, isoindolinone-based pigments, azomethine azo-based pigments, aniline black-based pigments, triphenylmethane-based pigments, perinone-based pigments, perylene-based pigments, quinophthalone-based pigments, dioxazine-based pigments, and quinacridone-based pigments (such as quinacridone red).

Examples of the dye include azo-based dyes, anthraquinone-based dyes, quinophthalone-based dyes, styryl-based dyes, diphenylmethane-based dyes, triphenylmethane-based dyes, oxazine-based dyes, triazine-based dyes, xanthane-based dyes, azomethine-based dyes, acridine-based dyes, and diazine-based dyes.

When the second colorant is used, the content of the second colorant can be approximately 0.1 mass % or higher, approximately 0.5 mass % or higher, or approximately 1 mass % or higher, and approximately 45 mass % or lower, approximately 40 mass % or lower, or approximately 35 mass % or lower based on the mass of the colored adhesive layer.

When the second colorant is used, the total content of titanium oxide and the second colorant can be higher than approximately 5 mass %, approximately 10 mass % or higher, or approximately 15 mass % or higher, and approximately 50 mass % or lower, approximately 45 mass % or lower, or approximately 40 mass % or lower based on the mass of the colored adhesive layer.

At least one of the carboxy group-containing (meth)acrylic polymer or the amino group-containing (meth)acrylic polymer may function as a dispersant for titanium oxide and the optional second colorant. In this embodiment, titanium oxide and the optional second colorant as well as the (meth)acrylic polymer that functions as a dispersant may be mixed to prepare a premix (also referred to as a millbase), and the resulting premix may be mixed with another component of a colored adhesive composition used to form the colored adhesive layer. Consequently, a large amount of titanium oxide and the optional second colorant can be stably dispersed in the colored adhesive layer. A premix is prepared for each of a plurality of second colorant, these premixes are appropriately mixed, thereby color matching can also be facilitated.

The carboxy group-containing (meth)acrylic polymer or the amino group-containing (meth)acrylic polymer that functions as a dispersant may be the same or different from the substance that functions as the acrylic adhesive polymer or the acrylic polymer additive. In the latter case, the colored adhesive layer contains two or more types of carboxy group-containing (meth)acrylic polymers or amino group-containing (meth)acrylic polymers, that is, contains a carboxy group-containing (meth)acrylic polymer or amino group-containing (meth)acrylic polymer that functions as a dispersant, and a carboxy group-containing (meth)acrylic polymer or amino group-containing (meth)acrylic polymer that functions as an acrylic adhesive polymer or acrylic polymer additive.

The weight average molecular weight (Mw) of the carboxy group-containing (meth)acrylic polymer or amino group-containing (meth)acrylic polymer that functions as the dispersant can be typically approximately 1000 or greater or approximately 10000 or greater, and approximately 1500000 or less or approximately 800000 or less.

The colored adhesive layer can be formed on the second layer of the fluororesin-based film layer or the liner using a colored adhesive composition containing the carboxy group-containing (meth)acrylic polymer, the amino group-containing (meth)acrylic polymer, and titanium oxide, and, as necessary, the second colorant, a crosslinking agent, a solvent, and/or an additional additive.

Before preparing the colored adhesive composition, titanium oxide and the optional second colorant as well as the carboxy group-containing (meth)acrylic polymer or amino group-containing (meth)acrylic polymer that functions as a dispersant may be mixed to prepare a premix. The mixing can be performed by using, for example, a paint shaker, a sand grind mill, a ball mill, an attritor mill, or a three roll mill. At the time of mixing, as necessary, a water-based solvent or an organic solvent may be added. The resulting premix is mixed with an additional component of the colored adhesive composition, and the colored adhesive composition can be prepared. When a plurality of the second colorants are used, a premix may be prepared for each colorant, and these premixes are appropriately mixed to match color, and then the premix mixture may be mixed with another component of the colored adhesive composition.

The mass ratio of the total of titanium oxide and the second colorant to the dispersant can be approximately from 1 to 100:approximately from 5 to 1000, approximately from 1 to 100:approximately from 10 to 700, or approximately from 1 to 100:approximately from 10 to 500. The entire amount of the dispersant may be used during preparation of the premix, or part of the dispersant may be used during preparation of the premix and the rest of the dispersant may be used during preparation of the colored adhesive composition.

The crosslinking agent is not particularly limited as long as the crosslinking agent can form a crosslink between polymer chains of the carboxy group-containing (meth)acrylic polymer or amino group-containing (meth)acrylic polymer. For example, as the crosslinking agent of the carboxy group-containing (meth)acrylic polymer, an epoxy crosslinking agent, a bisamide crosslinking agent, an aziridine crosslinking agent, a carbodiimide crosslinking agent, or an isocyanate crosslinking agent can be used.

Examples of the epoxy crosslinking agent include N,N,N′,N′-tetraglycidyl-1,3-benzenedi(methanamine) (trade name: TETRAD-X (Mitsubishi Gas Chemical Company Inc., Chiyoda-ku, Tokyo, Japan), E-AX and E-5XM (both from Soken Chemical & Engineering Co., Ltd., Toshima-ku, Tokyo, Japan)); and N,N′-(cyclohexane-1,3-diylbismethylene)bis(diglycidylamine) (trade name: TETRAD-C (Mitsubishi Gas Chemical Company Inc., Chiyoda-ku, Tokyo, Japan), and E-5C (Soken Chemical & Engineering Co., Ltd., Toshima-ku, Tokyo, Japan)).

Examples of the bisamide crosslinking agent include 1,1′-isophthaloyl-bis(2-methylaziridine), 1,4-bis(ethyleneiminocarbonylamino)benzene, 4,4′-bis(ethyleneiminocarbonylamino)diphenylmethane, and 1,8-bis(ethyleneiminocarbonylamino)octane.

Examples of the aziridine crosslinking agent include 2,2-bishydroxymethylbutanol-tris[3-(1-aziridinyl)propionate (trade name: CHEMITITE (trade name) PZ-33 (Nippon Shokubai Co., Ltd. (Osaka-shi, Osaka, Japan)), and Crosslinker CX-100 (DSM Coating Resins B. V. (Zwolle, Netherlands)).

Examples of the carbodiimide crosslinking agent include Carbodilite V-03, V-05, and V-07 (all from Nisshinbo Chemical Inc. (Chuo-ku, Tokyo, Japan)).

Examples of the isocyanate crosslinking agent include Coronate L and Coronate HK (both from Tosoh Corporation (Minato-ku, Tokyo, Japan)).

The crosslinking agent can be used in an amount of approximately 0.01 parts by mass or greater, approximately 0.02 parts by mass or greater, or approximately 0.05 parts by mass or greater, and approximately 0.5 parts by mass or less, approximately 0.4 parts by mass or less, or approximately 0.3 parts by mass or less, per 100 parts by mass of the carboxy group-containing (meth)acrylic polymer or amino group-containing (meth)acrylic polymer that functions as the acrylic adhesive polymer.

Examples of the solvent include methanol, ethanol, hexane, heptane, toluene, acetone, methyl ethyl ketone, methyl isobutyl ketone, ethyl acetate, butyl acetate, and mixed solvents thereof.

Examples of other additives include UV absorbents, antioxidants, thermal stabilizers, fillers, and tackifiers.

In an embodiment, the colored adhesive layer contains substantially no flame retardant. Here, “contains substantially no” means that the content of the flame retardant is less than approximately 1 mass %, less than approximately 0.5 mass %, or less than approximately 0.2 mass % based on the mass of the colored adhesive layer. Examples of the flame retardant include organic flame retardants such as bromine-based flame retardants, phosphorus-based flame retardants, and chlorine-based flame retardants, and inorganic flame retardants such as antimony compounds, metal hydroxides, nitrogen compounds, and boron compounds. The colored adhesive layer containing substantially no flame retardant causes no decrease in adhesive strength or no yellowing due to the migration of a flame retardant and thus can retain the adhesive strength and appearance of the decorative film over a long period of time. In the present disclosure, titanium oxide is not included in the content of the flame retardant.

The colored adhesive layer may vary in thickness; for example, the thickness can be approximately 5 μm or greater, approximately 10 μm or greater, or approximately 20 μm or greater, and approximately 200 μm or less, approximately 100 μm or less, or approximately 80 μm or less. From the viewpoint of nonflammability of the decorative film, the thickness of the colored adhesive layer is preferably approximately 50 μm or less and more preferably approximately 30 μm or less.

The decorative film can be produced by a known method. For example, the colored adhesive composition is applied onto a liner with a knife coater, a bar coater, or the like and dried to form a colored adhesive layer. To react a crosslinking agent used as an optional component, the colored adhesive layer may be heated using hot air, an oven, or the like during the drying. A fluororesin-based film layer is laminated on the resulting colored adhesive layer by a method, such as dry lamination, to bring the second layer of the fluororesin-based film layer in contact with the colored adhesive layer, and the decorative film can be produced. The decorative film can also be produced by directly applying the colored adhesive composition on the second layer of the fluororesin-based film layer and drying.

The decorative film may have a liner on the surface of the colored adhesive layer on the opposite side of the fluororesin-based film layer. Examples of the liner, which is an optional component, include plastic materials such as polyethylenes, polypropylenes, polyesters, and cellulose acetates, papers, and laminated papers of the plastic materials. These liners may have a surface that has been subjected to release-liner treatment with silicone or the like. The thickness of the liner can be typically approximately 10 μm or greater, or approximately 25 μm or greater, and approximately 500 μm or less, or approximately 200 μm or less.

The colored adhesive layer may be solid or may be a porous or foam body. The adhesive surface of the colored adhesive layer may be flat or may have recesses and protrusions. The adhesive surface with recesses and protrusions include an adhesive surface of the colored adhesive layer, in which the protrusions containing a solid content of the colored adhesive composition or a solid content of the reaction product and the recesses surrounding the protrusions are formed, and when the adhesive surface is attached to an adherend, a communicating passage is formed between the adherend surface and the adhesive surface, the communicating passage being defined by the recesses and being in communication with the external space. An example of the method for forming the adhesive surface with recesses and protrusions will be described below.

A liner with a release surface including a prescribed recess-and-protrusion structure is prepared. The colored adhesive composition is applied to the release surface of this liner and heated as necessary to form a colored adhesive layer. Consequently, the recess-and-protrusion structure (negative structure) of the liner is transferred to the face that is in contact with the liner of the colored adhesive layer (this face serves as the adhesive surface of the decorative film), and an adhesive surface having recesses and protrusions with the prescribed structure (positive structure) is formed on the adhesive surface. As described above, the recesses and protrusions of the adhesive surface are designed in advance to include a groove that allows formation of the communicating passage when the protrusions adhere to the adherend.

For the groove of the colored adhesive layer, the groove having a consistent shape may be arranged at the adhesive surface in accordance with a regular pattern to form a regularly-patterned groove, or the groove having an indeterminate shape may be arranged to form an irregularly-patterned groove. In a case where multiple grooves are formed to be disposed substantially parallel to each other, the interval at which the grooves are disposed is preferably approximately 10 μm or greater, or approximately 100 μm or greater, and approximately 2000 μm or less, or approximately 1000 μm or less. The depth of the groove (distance from the adhesive surface to the bottom of the groove measured toward the direction of the fluororesin-based film layer) is typically approximately 10 μm or greater and approximately 100 μm or less. The shape of the groove is also not particularly limited, as long as the effect of the present invention is not impaired. For example, the shape of the groove may be substantially rectangular (including trapezoidal), substantially semi-circular, or substantially semi-elliptical at a cross-section of the groove in a direction perpendicular to the adhesive surface.

The thickness of the decorative film is approximately 250 μm or less. The decorative film having a thickness of approximately 250 μm or less can impart required flame retardance to the decorative film. In the present disclosure, the thickness of the decorative film does not include the thickness of the liner. The thickness of the decorative film can be approximately 200 μm or less or approximately 100 μm or less. The thickness of the decorative film can be approximately 30 μm or greater, approximately 40 μm or greater, or approximately 50 μm or greater.

In an embodiment, the visible light transmittance of the decorative film excluding the liner is approximately 10% or higher, approximately 30% or higher, or approximately 50% or higher, and approximately 99% or lower, approximately 97% or lower, or approximately 95% or lower.

The decorative film has a total heat release of 8 MJ/m² or less for 20 minutes after start of heating as measured in accordance with ISO 5660-1 cone calorimeter heat release test. In an embodiment, the total heat release is approximately 7 MJ/m² or less, or approximately 6 MJ/m² or less. The decorative film having a total heat release of 8 MJ/m² or less is evaluated as being nonflammable.

The decorative film of the present disclosure can be suitably used for exterior purposes, such as vehicles, such as railways and ships; and exterior walls, such as those of buildings, storage tanks, and transformer facilities. In an embodiment, the decorative film is for vehicles.

### EXAMPLES

In the following examples, specific embodiments of the present disclosure will be exemplified, but the present invention is not limited to those embodiments. All ‘part’ and ‘percent’ are based on mass unless otherwise specified.

The raw materials used in the production of the decorative film are shown in Table 1.

TABLE 1

| | Composition or description ¹⁾ | Supplier |
|---|---|---|
| Film 1 (FL1) | Denka DX Film DX-14 S02, | Denka Company |
| | transparent grade, 30 μm in | Limited |
| | thickness | (Chuo-ku, Tokyo, |
| | | Japan) |
| (Meth)acrylic | MMA-BMA-DMAEMA = | — |
| polymer 1 (AP1) | 60:34:6, Tg = 63° C., weight | |
| | average molecular weight (Mw) | |
| | 68000, 40 mass % EtOAc solution | |
| (Meth)acrylic | BA-2EHA-Vac-AA-ACM = | — |
| polymer 2 (AP2) | 40:47:8:5:0.1, Tg = −51° C., weight | |
| | average molecular weight (Mw) | |
| | 550000, 40 mass % | |
| | toluene/EtOAc solution | |
| Adhesive polymer | BA-2EHA-AN-AA = 58:36:2:4, | — |
| 1 (ADH1) | Tg = −53° C., weight average | |
| | molecular weight (Mw) 500000, | |
| | 33 mass % EtOAc solution | |
| Adhesive polymer | BA-AA = 96:4, Tg = −50° C., | — |
| 2 (ADH2) | weight average molecular weight | |
| | (Mw) 580000, 42 mass % | |
| | toluene/EtOAc solution | |
| Crosslinking | Bisamide-based crosslinking | 3M Japan Limited |
| agent 1 (CL1) | agent, 1,1′-isophthaloyl-bis(2- | (Shinagawa-ku, |
| | methylaziridine), 5 mass % | Tokyo, Japan) |
| | toluene solution | |
| Crosslinking | Tetrad-X, polyfunctional liquid | Mitsubishi Gas |
| agent 2 (CL2) | epoxy resin, N,N′-tetraglycidyl- | Chemical Company, |
| | m-xylenediamine | Inc. |
| | | (Chiyoda-ku, Tokyo, |
| | | Japan) |

¹⁾ MMA, methyl methacrylate; BMA, n-butyl methacrylate; DMAEMA, dimethyl aminoethyl methacrylate; BA, n-butyl acrylate; 2EHA, 2-ethylhexyl acrylate; Vac, vinyl acetate; AA, acetic acid; ACM, acrylamide; AN, acrylonitrile; and EtOAc, ethyl acetate

The pigments 1 to 4 used in the production of the decorative films are shown in Table 2.

TABLE 2

| | Color | C.I. | Description | Supplier |
|---|---|---|---|---|
| Pigment 1 | White | — | TiPure (trade name) | The Chemours |
| (PG1) | | | R960, titanium | Company |
| | | | dioxide (TiO₂) | (Wilmington, |
| | | | | Delaware, US) |
| Pigment 2 | Orange | Pigment | CROMOPHTAL | BASF |
| (PG2) | | Orange 61 | (trade name) | (Basel, Switzerland) |
| | | | ORANGE 2G | |
| Pigment 3 | Yellow | Pigment | IRGAZIN (trade | BASF |
| (PG3) | | Yellow | name) | (Basel, Switzerland) |
| | | 154 | YELLOW 2GLTE | |
| Pigment 4 | Black | Pigment | Raven (trade name) | Columbian |
| (PG4) | | Black 7 | Carbon Black 1200 | Chemicals Company |
| | | | | (Marietta, Georgia, |
| | | | | US) |

The compositions of Millbases 1 to 4 (premixes) used in production of decorative films are shown in Table 3.

TABLE 3

Resin

| | |
|---|---|
| Pigment | mass % |

| | Type | mass % | Type | Solid content |
|---|---|---|---|---|
| Millbase 1 (MB1) | PG1 | 55 | AP1 | 11 |
| Millbase 2 (MB2) | PG2 | 10 | AP2 | 16 |
| Millbase 3 (MB3) | PG3 | 10 | AP2 | 16 |
| Millbase 4 (MB4) | PG4 | 5 | AP2 | 20 |

The compositions of colored adhesive compositions CA1 to CA3 used in production of decorative films are shown in Table 4.

TABLE 4
(numerical values are in wet mass %)

| | Colored adhesive composition | | |
|---|---|---|---|
| | CA1 | CA2 | CA3 |
| MB1 | 15 | 6 | 5 |
| MB2 | 6 | 11 | 11 |
| MB3 | 8 | 11 | 4 |
| MB4 | 1 | 1 | 3 |
| ADH2 | 70 | 69 | 75 |
| AP1 | — | 2 | 2 |

### Example 1

The crosslinking agent 1 (CL1) was mixed into the colored adhesive composition CA1. The mass ratio of the adhesive polymer 2 (ADH2) in the CA1 to the CL1 was 100:0.05 based on non-volatile content. The obtained colored adhesive composition was applied on a liner having a structured surface (SCW860DNL, 3M Japan Ltd., Minato-ku, Tokyo, Japan) by using a knife coater and dried at 95° C. for 3 minutes. After drying, a colored adhesive layer having a thickness of 25 μm was obtained. The colored adhesive layer was adhered to the PMMA-rich surface of the film 1 (FL1), and a decorative film of Example 1 was obtained.

### Example 2 and Example 3

Decorative films were obtained in the same manner as in Example 1 except for changing the colored adhesive compositions as shown in Table 5.

### Example 4

The white pigment premix containing the pigment 1 (PG1), which was a white pigment, the (meth)acrylic polymer 1 (AP1), and the methyl ethyl ketone (MEK) was prepared. The mass ratio of the PG1 to the AP1 was 5:1 based on non-volatile content. The solid content of the white pigment premix was approximately 66 mass %. A colored adhesive composition CA4 containing the white pigment premix and the adhesive polymer 1 (ADH1) was prepared. The mass ratio of the ADH1 to the PG1 to the API was 100:50:10 based on non-volatile content. The CL1 was mixed into the CA4, and thus a white adhesive composition was obtained. The mass ratio of the ADH1 to the CL1 was 100:0.2 based on non-volatile content. The solid content of the white adhesive composition was approximately 35 mass %.

The white adhesive composition was applied on a silicone-covered polyethylene-laminated paper liner by using a knife coater and dried at 95° C. for 5 minutes. After drying, a white adhesive layer having a thickness of 30 μm was obtained. The white adhesive layer was adhered to the PMMA-rich surface of the FL1, and a decorative film of Example 4 was obtained.

### Example 5

A white pigment premix was prepared in the same manner as in Example 4. Then, a colored adhesive composition CA5 containing the white pigment premix and the ADH2 was prepared. The mass ratio of the ADH2 to the PG1 to the API was 100:40:8 based on non-volatile content. The CL2 was mixed into the CA5, and thus a white adhesive composition was obtained. The mass ratio of the ADH2 to the CL2 was 100:0.05 based on non-volatile content. The solid content of the white adhesive composition was approximately 38 mass %.

The white adhesive composition was applied on a silicone-covered polyethylene-laminated paper liner by using a knife coater and dried at 95° C. for 5 minutes. After drying, a white adhesive layer having a thickness of 40 μm was obtained. The white adhesive layer was adhered to the PMMA-rich surface of the FL1, and a decorative film of Example 5 was obtained.

### Comparative Example 1

As a decorative film of Comparative Example 1, a 3M (trade name) Scotchcal (trade name) over-laminate film IJ4114V (3M Japan Ltd., Minato-ku, Tokyo, Japan) was used.

The decorative film was evaluated for the following.

### 1. Adhesive Force

A test piece was prepared by cutting a decorative film into a width of 25 mm and a length of 150 mm. A test piece was adhered on a melamine-coated plate (Paltek Corporation, Hiratsuka-shi, Kanagawa-ken, Japan), A5052P aluminum panel, SUS304BA panel (Paltek Corporation, Hiratsuka-shi, Kanagawa-ken, Japan), or a float glass panel having a thickness of 3 mm (AGC Inc., Chiyoda-ku, Tokyo, Japan) at 20° C. The adhering method was in accordance with JIS Z 0237:2009 8.2.3. The test piece was left at 20° C. for 48 hours. Using a tensile tester (Tensilon (registered trademark) universal testing machine, model: RTC-1210A, A&D Company, Limited, Toshima-ku, Tokyo, Japan), the adhesive strength (N/25 mm) at the time of performing 180 degree peeling was measured at a peeling rate of 300 mm/min at a temperature of 20° C.

### 2. Removability

A test piece was prepared by cutting a decorative film into a width of 25 mm and a length of 150 mm. The test piece was adhered on a melamine-coated plate (Paltek Corporation, Hiratsuka-shi, Kanagawa, Japan) using a roller at 20° C. The test piece was allowed to stand at 65° C. for 168 hours, cooled to room temperature, and then peeled from the melamine-coated plate. A test piece for which no residue of the adhesive was observed on the melamine-coated plate was evaluated as A. A test piece for which residue of the adhesive was slightly observed on the melamine-coated plate but was able to be easily removed using isopropanol (IPA) was evaluated as B. A test piece for which a large amount of residue of the adhesive was observed on the melamine-coated plate and was difficult to completely remove was evaluated as C. A and B were determined to pass.

### 3. Heat Shrinkage

A test piece was prepared by cutting a decorative film into a width of 50 mm and a length of 100 mm. The test piece was adhered on an aluminum panel A5052P in an environment at 23° C. by a roller and left for 24 hours in an environment at 23° C. On the test piece, cut in shape of cross was made by a utility knife. The test piece was then heated at 65° C. for 48 hours. After the heat aging, the shrinkage (mm) of the film was measured by a microscope, and a maximum value was recorded.

### 4. Nonflammability Test

A decorative film was adhered on a zinc-plated steel plate (thickness: 0.27 mm). Test was conducted in accordance with ISO 5660-1 cone calorimeter heat release test. A heat release rate (kW/m²) and a total heat release (MJ/m²) were measured as parameters using a cone calorimeter (available from Toyo Seiki Seisaku-sho, Ltd.). When the total heat release for 20 minutes after start of heating was 8 MJ/m² or lower and the time indicating a heat release rate exceeding 200 kW/m² was 10 seconds or shorter in total, the decorative film was determined to pass, and otherwise the decorative film was determined to fail.

### 5. Anti-Smudge Properties

Numeric characters 8 were written on the fluororesin-based film layer of the decorative film with Hi-Mckee oil-based markers black and red (Zebra Co., Ltd., Shinjuku-ku, Tokyo, Japan). The decorative film was dried in a 23° C. environment for 5 minutes, then the ink was wiped off with isopropanol (IPA), and the appearance of the decorative film after drying was observed. The decorative film in which no trace of the ink was observed was evaluated as A. The decorative film in which a trace of the ink was observed was evaluated as B. A was determined to pass.

### 6. Solvent Resistance

Methyl ethyl ketone (MEK) was dropped on the fluororesin-based film layer of the decorative film, and the appearance of the decorative film after drying was observed. The decorative film in which no trace of MEK was observed was evaluated as A. The decorative film in which no dissolution of the decorative film was observed but a trace of MEK was observed was evaluated as B. The decorative film in which dissolution of the decorative film was observed was evaluated as C. A and B were determined to pass.

For the decorative films of Examples 1 to 5 and Comparative Example 1, the constitutions are shown in Table 5, and the evaluation results are shown in Table 6.

TABLE 5

| | | | | | | Adhesive layer | | |
|---|---|---|---|---|---|---|---|---|
| | | | | | | thickness | | |
| | Film | | Colored | Crosslinking agent | | [μm] | | Total |
| | | Thickness | adhesive | | Part by | Thickness | | thickness |
| | Type | [μm] | composition | Type | mass | [μm] | Color | [μm] |
| Example 1 | FL1 | 30 | CA1 | CL1 | 0.05 | 25 | Yes | 55 |
| Example 2 | FL1 | 30 | CA2 | CL1 | 0.05 | 25 | Yes | 55 |
| Example 3 | FL1 | 30 | CA3 | CL1 | 0.05 | 25 | Yes | 55 |
| Example 4 | FL1 | 30 | CA4 | CL1 | 0.20 | 30 | Yes | 60 |
| Example 5 | FL1 | 30 | CA5 | CL2 | 0.05 | 40 | Yes | 70 |
| Comparative | — | — | — | — | — | — | No | 60 |
| Example 1 | | | | | | | | |

TABLE 6

| | Adhesive strength [N/25 mm] | | | | | | | | |
|---|---|---|---|---|---|---|---|---|---|
| | Melamine- | | | | | Heat | | Anti- | |
| | coated | | | | | Shrinkage | Non- | smudge | Solvent |
| | plate | Al | SUS | Glass | Removability | [mm] | flammability | properties | resistance |
| Example 1 | 12 | 19 | 7 | 18 | A | 0.10 | Pass | A | A |
| Example 2 | 12 | 18 | 7 | 17 | A | 0.10 | Pass | A | A |
| Example 3 | 13 | 18 | 8 | 16 | A | 0.13 | Pass | A | A |
| Example 4 | 13 | 22 | 8 | 19 | A | 0.12 | Pass | A | A |
| Example 5 | 18 | 26 | 10 | 24 | A | 0.14 | Pass | A | A |
| Comparative | 20 | 27 | 18 | 26 | A | 0.14 | Pass | A | A |
| Example 1 | | | | | | | | | |

Various variations of the above-mentioned embodiments and examples will be apparent to those skilled in the art without departing from the basic principle of the present invention. It is also obvious to a person skilled in the art that various improvement and modifications to the present invention can be implemented without departing from the spirit and scope of the present invention. A part of embodiments of the present disclosure is described below.

### Embodiment 1

A decorative film for exteriors, comprising a fluororesin-based film layer and a colored adhesive layer, wherein
the colored adhesive layer comprises a carboxy group-containing (meth)acrylic polymer, an amino group-containing (meth)acrylic polymer, and from 5 mass % to 50 mass % of titanium oxide based on mass of the colored adhesive layer;
the fluororesin-based film layer comprises a first layer containing a vinylidene fluoride-based resin and a second layer containing a methacrylate-based resin;
the second layer of the fluororesin-based film layer is in contact with the colored adhesive layer; and
the decorative film for exteriors has a thickness of 250 μm or less, and a total heat release for 20 minutes after start of heating is 8 MJ/m² or lower as measured in accordance with the ISO 5660-1 cone calorimeter heat release test.

### Embodiment 2

The decorative film for exteriors according to the embodiment 1, wherein the second layer of the fluororesin-based film layer comprises at least one selected from the group consisting of a UV absorbent and a hindered amine light stabilizer.

### Embodiment 3

The decorative film for exteriors according to the embodiment 1 or 2, wherein the first layer comprises from 95 parts by mass to 50 parts by mass of a vinylidene fluoride-based resin and from 5 parts by mass to 50 parts by mass of a methacrylate-based resin, and the second layer comprises from 95 parts by mass to 5 parts by mass of a methacrylate-based resin and from 5 parts by mass to 95 parts by mass of a vinylidene fluoride-based resin.

### Embodiment 4

The decorative film for exteriors according to any one from the embodiments 1 to 3, wherein the colored adhesive layer contains substantially no flame retardant.

### Embodiment 5

The decorative film for exteriors according to any one of the embodiments 1 to 4, wherein a total light transmittance of the fluororesin-based film layer in a wavelength range from 380 nm to 780 nm is 80% or higher.

### Embodiment 6

The decorative film for exteriors according to any one of the embodiments 1 to 5, wherein the decorative film for exteriors is for vehicles.

### REFERENCE SIGNS LIST

10: Decorative film for exterior
12: Fluororesin-based film layer
122: First layer
124: Second layer
14: Colored adhesive layer
16: Liner

1. A decorative film for exteriors, comprising a fluororesin-based film layer and a colored adhesive layer, wherein
the colored adhesive layer comprises a carboxy group-containing (meth)acrylic polymer, an amino group-containing (meth)acrylic polymer, and from 5 mass % to 50 mass % of titanium oxide based on mass of the colored adhesive layer;
the fluororesin-based film layer comprises a first layer containing a vinylidene fluoride-based resin and a second layer containing a methacrylate-based resin;
the second layer of the fluororesin-based film layer is in contact with the colored adhesive layer; and
the decorative film for exteriors has a thickness of 250 μm or less, and a total heat release for 20 minutes after start of heating is 8 MJ/m² or lower as measured in accordance with the ISO 5660-1 cone calorimeter heat release test.

2. The decorative film for exteriors according to claim 1, wherein the second layer of the fluororesin-based film layer comprises at least one selected from the group consisting of a UV absorbent and a hindered amine light stabilizer.

3. The decorative film for exteriors according to claim 1, wherein the first layer comprises from 95 parts by mass to 50 parts by mass of a vinylidene fluoride-based resin and from 5 parts by mass to 50 parts by mass of a methacrylate-based resin, and the second layer comprises from 95 parts by mass to 5 parts by mass of a methacrylate-based resin and from 5 parts by mass to 95 parts by mass of a vinylidene fluoride-based resin.

4. The decorative film for exteriors according to claim 1, wherein the colored adhesive layer contains substantially no flame retardant.

5. The decorative film for exteriors according to claim 1, wherein a total light transmittance of the fluororesin-based film layer in a wavelength range from 380 nm to 780 nm is 80% or higher.

6. The decorative film for exteriors according to claim 1, wherein the decorative film for exteriors is for vehicles.
